(19) United States
(12) Patent Application Publication
(10) Pub. No.: US 2009/0116360 A1
(43) Pub. Date: May 7, 2009

(54) OPTICAL RECORDING MEDIUM, OPTICAL RECORDING DEVICE, AND OPTICAL REPRODUCING DEVICE

(75) Inventors: Yoshiyuki Matsumura, Anpachi-Gun (JP); Seiichiro Takahashi, Gifu-Shi (JP); Kazuya Kogure, Kiryu-Shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/260,265

(22) Filed: Oct. 29, 2008

(30) Foreign Application Priority Data
Nov. 1, 2007 (JP) 2007-285579

(51) Int. Cl. G11B 3/74

(52) U.S. Cl. 369/94; G9B/3.108

(57) ABSTRACT

An optical recording medium has a first recording layer, and a second recording layer contiguous to the first recording layer in a laminated direction. A recording operation is performed with respect to the first recording layer and the second recording layer in such a manner that frequency bands of reproducing signals are different from each other.

This application claims priorities under 35 U.S.C. Section 119 of Japanese Patent Application No. 2007-285579 filed Nov. 1, 2007, entitled “OPTICAL RECORDING MEDIUM, OPTICAL RECORDING DEVICE, AND OPTICAL REPRODUCING DEVICE”.

### BACKGROUND OF THE INVENTION

1. Field of the Invention

The present invention relates to an optical recording medium having multiple recording layers in a laminated direction, and an optical recording device and an optical reproducing device suitably used in recording and reproducing information on and from the optical recording medium.

2. Disclosure of Related Art

In recent years, the technology of increasing the capacity of a recording medium has been developed. The capacity of a recording medium can be increased by forming multiple recording layers in a laminated direction, as well as increasing the recording density. Laminating the recording layers, however, causes a drawback that reflection light (stray light) from a recording layer other than a targeted recording layer to be reproduced may be incident on a photodetector, thereby degrading the signal quality.

The above drawback can be eliminated by forming a polarized light separating layer for selectively transmitting light having a specific polarization direction between a first recording layer and a second recording layer. In this arrangement, in recording and reproducing information on and from the first recording layer, laser light is irradiated onto a recording medium in a polarization direction where light is not transmitted through the polarized light separating layer; and in recording and reproducing information on and from the second recording layer, laser light is irradiated onto the recording medium in a polarization direction where light is transmitted through the polarization light separating layer. This arrangement is advantageous in suppressing incidence of stray light from a recording layer other than a targeted recording layer to be recorded and reproduced, thereby improving the signal quality.

In the above arrangement, however, since the polarization directions are fixed with respect to the first recording layer and the second recording layer, respectively, at most two recording layers are laminated in one recording medium. In other words, increasing the capacity of a recording medium is restricted to the operation of laminating two recording layers in a recording medium.

### SUMMARY OF THE INVENTION

An object of the invention is to provide an arrangement that enables to increase the capacity of a recording medium with no limitation on the number of recording layers.

A first aspect of the invention is directed to an optical recording medium. The optical recording medium according to the first aspect includes a first recording layer, and a second recording layer contiguous to the first recording layer in a laminated direction, wherein a recording is performed with respect to the first recording layer and the second recording layer in such a manner that a frequency band of a signal based on light modulated by the first recording layer in reproducing from the first recording layer is different from a frequency band of a signal based on light modulated by the second recording layer in reproducing from the first recording layer.

A second aspect of the invention is directed to an optical recording device for recording on an optical recording medium having multiple recording layers in a laminated direction. The optical recording device according to the second aspect includes: a first modulating circuit for modulating a recording signal in accordance with a first modulating method corresponding to a first recording layer; a second modulating circuit for modulating the recording signal in accordance with a second modulating method corresponding to a second recording layer contiguous to the first recording layer in the laminated direction; and a selecting circuit for selecting one of the first modulating circuit and the second modulating circuit, as a modulating circuit for modulating the recording signal, depending on the recording layer to be recorded, wherein the first modulating method and the second modulating method are modulating methods different from each other in a frequency band of the modulated signal.

A third aspect of the invention is directed to an optical reproducing device. The optical reproducing device according to the third aspect is adapted to reproduce from an optical recording medium having multiple recording layers in a laminated direction, and includes: an extracting circuit for extracting a first frequency component corresponding to a first recording layer, and a second frequency component corresponding to a second recording layer contiguous to the first recording layer in the laminated direction respectively from a reproducing signal based on light modulated by the optical recording medium; a first demodulating circuit for demodulating a reproducing signal of the first frequency component; a second demodulating circuit for demodulating a reproducing signal of the second frequency component; and a selecting circuit for selecting one of a first demodulated signal demodulated by the first demodulating circuit, and a second demodulated signal demodulated by the second demodulating circuit, as a demodulated signal to be used in the reproduction, depending on the recording layer to be reproduced.

### BRIEF DESCRIPTION OF THE DRAWINGS

These and other objects, and novel features of the present invention will become more apparent upon reading the following detailed description along with the accompanying drawings.

FIGS. 1A and 1B are diagrams showing an arrangement of an optical disc embodying the present invention.

FIG. 2A is a top plan view of an optical system in an optical pickup device embodying the present invention.

FIG. 2B is a partial side view of the optical system in the optical pickup device in the embodiment of the present invention.

FIG. 3 is a diagram showing an arrangement of an optical disc device embodying the present invention.

FIGS. 4A and 4B are diagrams showing modulating methods (code conversion tables) in the embodiment of the present invention.

FIGS. 5A and 5B are diagrams showing filter characteristics of a first filtering circuit and a second filtering circuit in the embodiment of the present invention, respectively.

FIG. 6 is a flowchart showing an operation flow in the case where a reproducing operation is performed in the optical disc device in the embodiment of the present invention.

FIG. 7 is a flowchart showing an operation flow in the case where a recording operation is performed in the optical disc device in the embodiment of the present invention.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, a recordable optical disc is illustrated as an example of an optical recording medium.

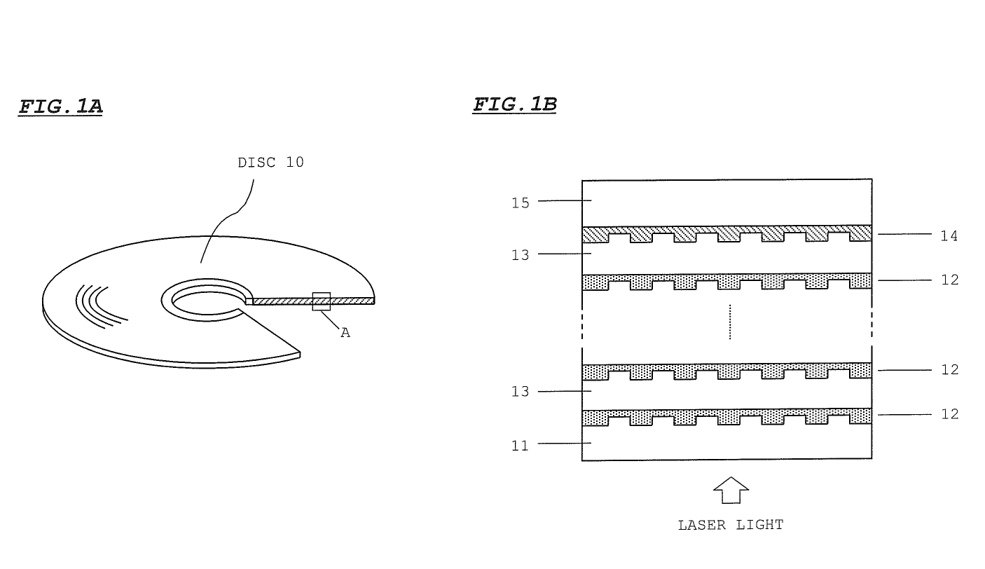

FIGS. 1A and 1B are diagrams showing an arrangement of a disc (optical recording medium) 10 embodying the invention. FIG. 1A is a diagram showing an external appearance of the disc 10, wherein the disc 10 is partially cutaway into a fan-like shape. FIG. 1B is a diagram schematically showing a cross-sectional structure of a portion “A” in FIG. 1A.

As shown in FIG. 1B, the disc 10 has a structure that recording layers 12 and intermediate layers 13 are formed one over another on a substrate 11 in a laminated direction. The substrate 11 is made of polycarbonate. The recording layers 12 each is formed by laminating a recording film and a semi-transparent film. The film structure and the material of the recording layers 12 are substantially the same as those of a well-known multilayered disc. The intermediate layers 13 are made of a light transmissive resin such as a UV cured resin.

A recording layer 14 farthest from a laser light incident plane is formed by laminating a recording film and a reflective film (e.g. an aluminum film). A cover layer 15 is formed on the recording layer 14. The cover layer 15 is made of e.g. a UV cured resin.

The track structure of each recording layer may be substantially the same as that of a well-known multilayered disc. For instance, a land track and a groove track are spirally formed on each recording layer of the disc 10, and pit rows are formed on an inner peripheral portion of the disc 10 in a spiral manner.

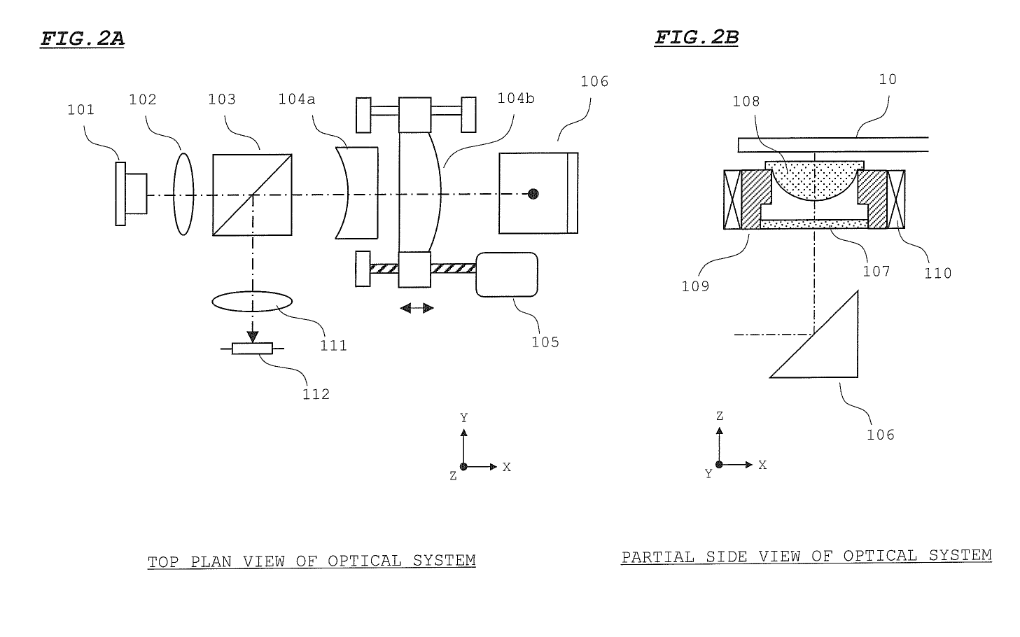

FIGS. 2A and 2B are diagrams showing an arrangement of an optical pickup device embodying the invention. FIG. 2A is a plan view of an optical system excluding an arrangement posterior to a rise-up mirror 106. FIG. 2B is a side view of a portion posterior to the rise-up mirror 106. In FIG. 2B, a quarter wavelength plate 107, an objective lens 108, and a lens holder 109 are illustrated in cross section.

As shown in FIGS. 2A and 2B, the optical system in the optical pickup device includes a semiconductor laser 101, a collimator lens 102, a polarized beam splitter 103, a concave lens 104a and a convex lens 104b constituting a beam expander (for aberration correction), a lens actuator 105 for driving the concave lens 104b in the optical axis direction, the rise-up mirror 106, the quarter wavelength plate 107, the objective lens 108, the objective lens holder 109, an objective lens actuator 110, an anamorphic lens 111, and a photodetector 112.

The semiconductor laser 101 emits laser light (straight polarized light) of a predetermined wavelength. Laser light emitted from the semiconductor laser 101 is collimated into parallel light by the collimator lens 102 for incidence onto the polarized beam splitter 103. In this embodiment, the semiconductor laser 101 is arranged at such a position that the laser light is incident onto the polarized beam splitter 103 as P-polarized light. Thereby, the laser light is transmitted through the polarized beam splitter 103.

Thereafter, the laser light as parallel light is converged or diverged depending on aberration correction performance of the beam expander in transmitting through the concave lens 104a and the convex lens 104b. Then, the laser light is reflected in a direction toward the objective lens 108 by the rise-up mirror 106. Thereafter, the laser light is converted into circularly polarized light by the quarter wavelength plate 107 for convergence on a surface of the disc 10 through the objective lens 108. In the convergence, the objective lens 108 is driven in focus direction and tracking direction by the objective lens actuator 110. Thereby, the laser light is allowed to follow the track of a targeted recording layer.

The laser light reflected on the disc 10 returns along the optical path toward the disc 10 for incidence onto the polarized beam splitter 103. In the incidence, the laser light is converted into S-polarized light with respect to the polarized beam splitter 103 by transmitting through the quarter wavelength plate 107. Thereby, substantially the whole light amount of the laser light is reflected on the polarized beam splitter 103. Thereafter, after astigmatism is introduced by the anamorphic lens 111, the laser light is condensed on the photodetector 112.

In this embodiment, an astigmatism method is employed as a method for generating a focus error signal, and a one-beam push-pull method is employed as a method for generating a tracking error signal. In view of this, a sensor pattern (four-divided sensor) in accordance with the astigmatism method and the one-beam push-pull method is formed on the photodetector 112.

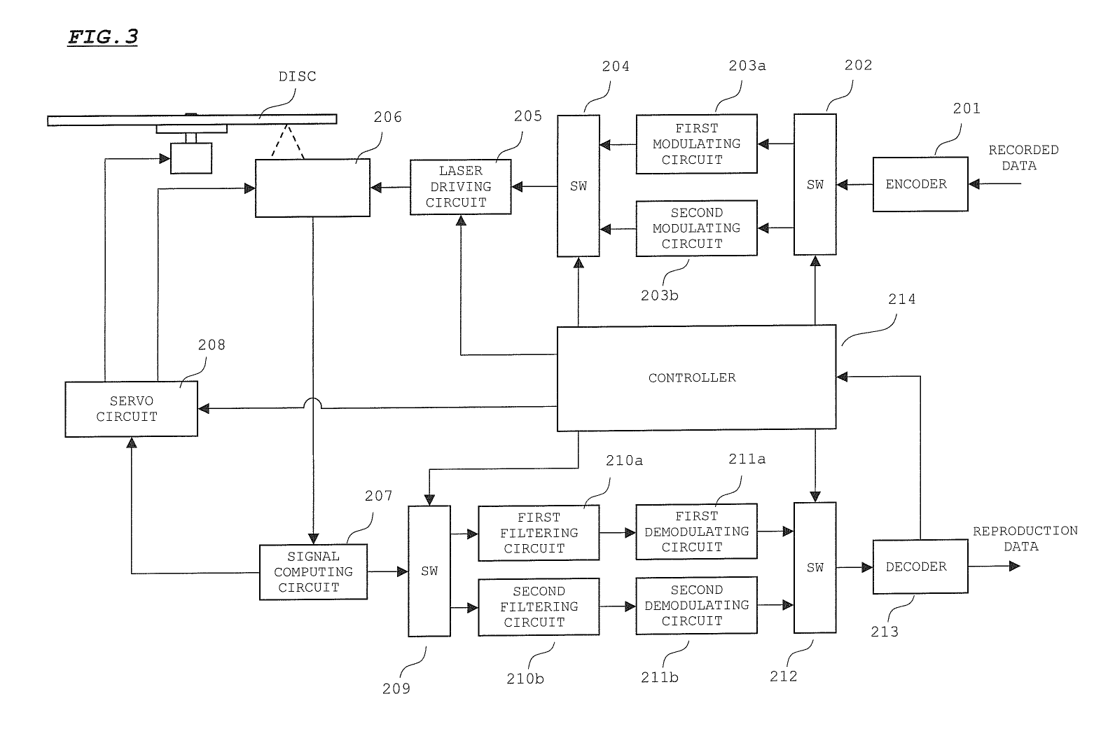

FIG. 3 is a diagram showing an arrangement of an optical disc device embodying the invention. In FIG. 3, solely a circuit system relating to recording and reproducing operations is illustrated.

Referring to FIG. 3, an encoder 201 performs an encoding operation of adding an error correction code to recorded data, or a like operation. A switching circuit 202 supplies a signal from the encoder 201 to one of a first modulating circuit 203a and a second modulating circuit 203b in accordance with a command from a controller 214.

The first modulating circuit 203a modulates an inputted signal in accordance with a first modulating method. The second modulating circuit 203b modulates an inputted signal in accordance with a second modulating method. In the case where a recording operation is performed with respect to an odd-numbered recording layer from the incident side of laser light, the first modulating circuit 203a is selected. In the case where a recording operation is performed with respect to an even-numbered recording layer from the incident side of laser light, the second modulating circuit 203b is selected.

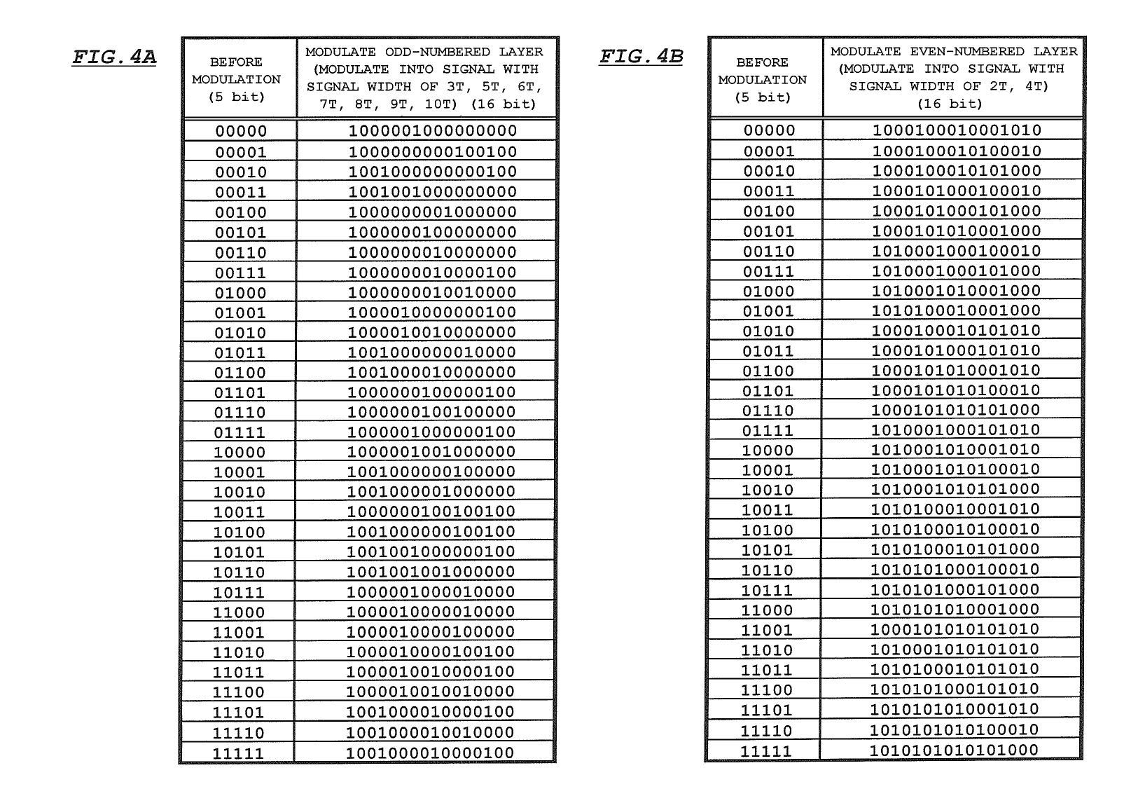

FIG. 4A is a diagram showing the first modulating method to be applied to the first modulating circuit 203a. In the first modulating method, a 5-bit data row is converted into a 16-bit data row in such a manner that the number of “0” digits is two, four, five, six, seven, or nine; and the “1” digit does not appear in series. Accordingly, in the case where a data row is NRZI (Non Return to Zero Inversion)-modulated, a signal with a signal width of 3 T, 5 T, 6 T, 7 T, 8 T, 9 T, or 10 T is generated. The first modulating circuit 203a performs code conversion based on a conversion table shown in FIG. 4A, generates a signal with a signal width of 3 T, 5 T, 6 T, 7 T, 8 T, 9 T, or 10 T by performing NRZI-modulation, and outputs the signal to a switching circuit 204.

FIG. 4B is a diagram showing the second modulating method to be applied to the second modulating circuit 203b. In the second modulating method, a 5-bit data row is converted into a 16-bit data row in such a manner that the number of “0” digits is one or three, and the “1” digit does not appear in series. Accordingly, in the case where a data row is NRZI-modulated, a signal with a signal width of 2 T or 4 T is generated. The second modulating circuit 203b performs code conversion based on a conversion table shown in FIG. 4B, generates a signal with a signal width of 2 T or 4 T by performing NRZI-modulation, and outputs the signal to the switching circuit 204.

Referring back to FIG. 3, the switching circuit 204 supplies a signal from one of the first modulating circuit 203a and the second modulating circuit 203b to a laser driving circuit 205 in accordance with a command from the controller 214. The laser driving circuit 205 drives the semiconductor laser 101 in the optical pickup device 206 in accordance with a command from the controller 214. Specifically, the laser driving circuit 205 outputs laser light of a high optical power which is modulated by a signal to be inputted from the switching circuit 204 in performing a recording operation; and outputs laser light of a constant level of optical power lower than the recording power in performing a reproducing operation.

The optical pickup device 206 has the arrangement as shown in FIG. 2. The optical pickup device 206 is supported on a pickup feed mechanism (not shown) to be movable in a radial direction of the disc 10.

A signal computing circuit 207 performs a computation with respect to a signal from the photodetector 112 in the optical pickup device 206 to generate various signals (reproduction RF signal, focus error signal, tracking error signal, and the like), and supplies the signals to respective corresponding circuits.

A servo circuit 208 generates a focus servo signal and a tracking servo signal based on a focus error signal and a tracking error signal inputted from the signal computing circuit 207, and supplies the focus servo signal and the tracking servo signal to the objective lens actuator 110 in the optical pickup device 206. The servo circuit 208 also supplies a signal for displacing the objective lens 108 in the optical axis direction to the objective lens actuator 110 in accordance with a command from the controller 214, in performing a focus search operation with respect to a targeted recording layer.

In performing a focus search operation, the servo circuit 208 counts the number of S-shaped curves on the focus error signal, as will be described later, to draw a focus point into a targeted recording layer. In addition, the servo circuit 208 supplies a drive signal to the lens actuator 105 in the optical pickup device 206 to optimize the reproduction RF signal.

A switching circuit 209 supplies the reproduction RF signal inputted from the signal computing circuit 207 to one of a first filtering circuit 210a and a second filtering circuit 210b in accordance with a command from the controller 214.

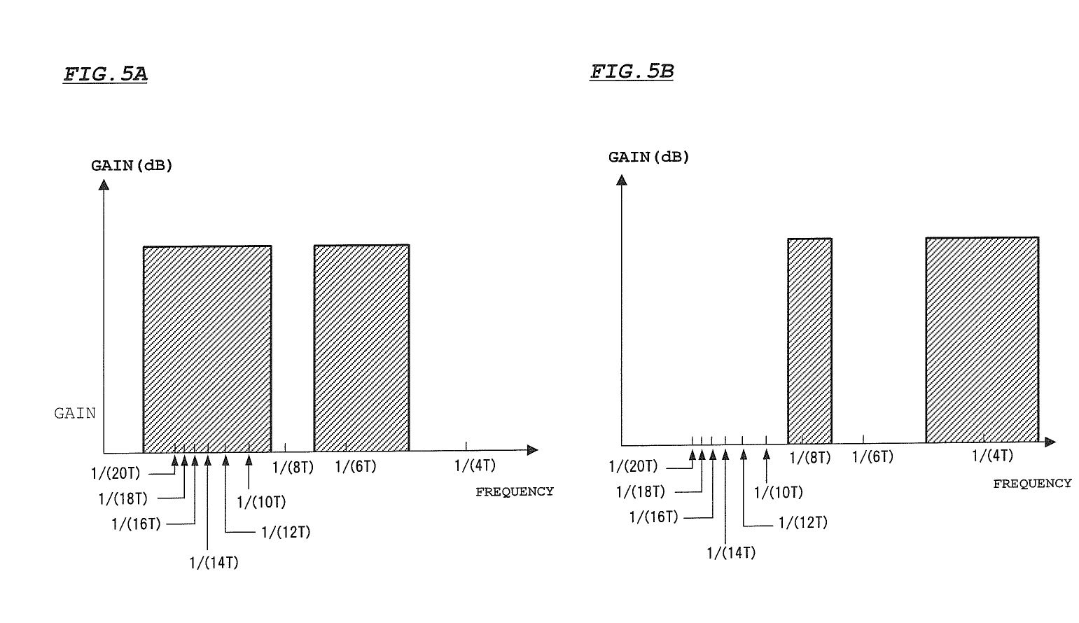

The first filtering circuit 210a is constituted of a comb-like filter for transmitting light in a frequency band of a reproduction RF signal to be obtained in reproducing from an odd-numbered recording layer on the disc 10, i.e. frequency bands of 1/(6 T), 1/(10 T), 1/(12 T), 1/(14 T), 1/(16 T), 1/(18 T), and 1/(20 T). The second filtering circuit 210b is constituted of a comb-like filter for transmitting light in a frequency band of a reproduction RF signal to be obtained in reproducing from an even-numbered recording layer on the disc 10, i.e. frequency bands of 1/(4 T) and 1/(8 T). FIG. 5A shows a transmittance characteristic of the first filtering circuit 210a, and FIG. 5B shows a transmittance characteristic of the second filtering circuit 210b.

In reproducing from an odd-numbered recording layer, the first filtering circuit 210a is operable to remove a reproduction signal component (noise component resulting from stray light) from a recording layer contiguous to a targeted recording layer to be reproduced in the laminated direction. Likewise, in reproducing from an even-numbered recording layer, the second filtering circuit 210b is operable to remove a reproduction signal component (noise component resulting from stray light) from a recording layer contiguous to a targeted recording layer to be reproduced in the laminated direction. Accordingly, demodulated signals having high reliability can be obtained by demodulating reproduction RF signals to be outputted from the first filtering circuit 210a and the second filtering circuit 210b in accordance with demodulating methods corresponding to an odd-number recording layer and an even-numbered recording layer, respectively.

Referring back to FIG. 3, a first demodulating circuit 211a NRZI-demodulates a reproduction RF signal inputted from the first filtering circuit 210a to generate a data row; and performs a conversion opposite to the code conversion to be performed by the first modulating circuit 203a with respect to the generated data row to generate a data row. Specifically, the first demodulating circuit 211a sequentially converts a 16-bit data row into a 5-bit data row based on the conversion table shown in FIG. 4A, and outputs the converted data row to a switching circuit 212.

A second demodulating circuit 211b NRZI-demodulates a reproduction RF signal inputted from the second filtering circuit 210b to generate a data row; and performs a conversion opposite to the code conversion to be performed by the second modulating circuit 203b with respect to the data row to generate a data row. Specifically, the second demodulating circuit 211b sequentially converts a 16-bit data row into a 5-bit data row based on the conversion table shown in FIG. 4B, and outputs the converted data row to the switching circuit 212.

The switching circuit 212 outputs one of the demodulated signals inputted from the first demodulating circuit 211a and the second demodulating circuit 211b to a decoder 213 in accordance with a command from the controller 214. The decoder 213 decodes the demodulated signal inputted from the switching circuit 212 to generate reproduction data, and outputs the reproduction data to a circuit provided posterior to the decoder 213. The decoder 213 also supplies a processing result to the controller 214.

The controller 214 controls the respective parts of the optical pickup device 206 in accordance with a control program stored in an internal memory.

In the arrangement shown in FIG. 3, in the case where a recording operation is performed with respect to an odd-numbered recording layer, the controller 214 controls the switching circuits 202 and 204 in such a manner that recorded data is processed along a route (hereinafter, called as a “first recording route”) constituted of the encoder 201, the first modulating circuit 203a, and the laser driving circuit 205 in this order. By performing the above operation, recording signals with signal widths of 3 T, 5 T, 6 T, 7 T, 8 T, 9 T, and 10 T are recorded in the odd-numbered recording layer.

In the case where a recording operation is performed with respect to an even-numbered recording layer, the controller 214 controls the switching circuits 202 and 204 in such a manner that recorded data is processed along a route (hereinafter, called as a “second recording route”) constituted of the encoder 201, the second modulating circuit 203b, and the laser driving circuit 205 in this order. By performing the above operation, recording signals with signal widths of 2 T and 4 T are recorded in the even-numbered recording layer.

In the case where a reproducing operation is performed with respect to an odd-numbered recording layer, the controller 214 controls the switching circuits 209 and 212 in such a manner that a reproduction RF signal from the signal computing circuit 207 is processed along a route (hereinafter, called as a “first reproducing route”) constituted of the first filtering circuit 210a, the first demodulating circuit 211a, and the decoder 213 in this order. By performing the above operation, reproduction RF signals with signal widths of 3 T, 5 T, 6 T, 7 T, 8 T, 9 T, and 10 T are extracted and reproduced in reproducing from the odd-numbered recording layer.

In the case where a reproducing operation is performed with respect to an even-numbered recording layer, the controller 214 controls the switching circuits 209 and 212 in such a manner that a reproduction RF signal from the signal computing circuit 207 is processed along a route (hereinafter, called as a “second reproducing route”) constituted of the second filtering circuit 210b, the second demodulating circuit 211b, and the decoder 213 in this order. By performing the above operation, reproduction RF signals with signal widths of 2T and 4T are extracted and reproduced in reproducing from the even-numbered recording layer.

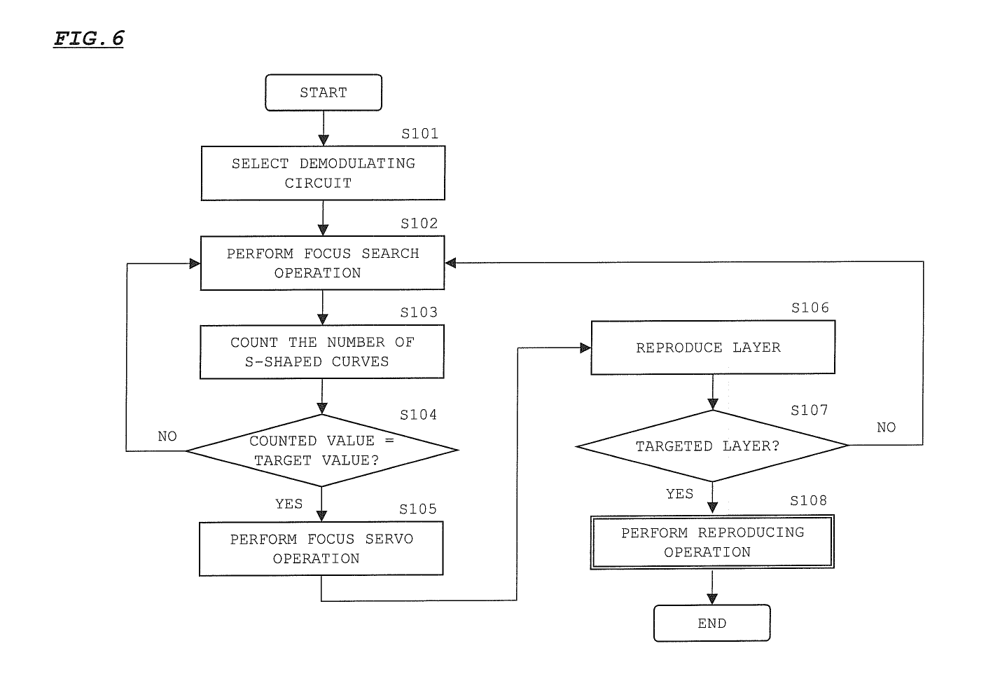

FIG. 6 is a flowchart showing an operation flow in performing a reproducing operation. Hereinafter, a recording layer is simply called as a “layer”.

When a reproducing operation is started, the switching circuits 209 and 212 are controlled to select a reproducing route corresponding to a targeted layer to be reproduced between the first and the second reproducing routes (Step S101). Then, a focus search operation is started (Step S102). In performing the focus search operation, the servo circuit 208 counts the number of S-shaped curves on a focus error signal (Step S103), and judges whether the counted value has reached a predetermined value (target value) corresponding to the targeted layer (Step S104). In this embodiment, the target value is supplied from the controller 214 to the servo circuit 208 at the time when the focus search operation is started.

Thereafter, if the counted value of S-shaped curves has reached the target value (YES in Step S104), the servo circuit 208 terminates the focus search operation, and a focus servo operation is started (Step S105). Thereby, the focus point of laser light is located on the targeted layer. Thereafter, the laser light is introduced to a management area (e.g. a pit forming area) of the targeted layer where the focus servo operation is performed to reproduce information from the management area (Step S106). Information is recorded in the management area with the same signal width (3 T, 5 T, 6 T, 7 T, 8 T, 9 T, and 10 T for an odd-numbered layer; 2 T and 4 T for an even-numbered layer) as the targeted layer to be reproduced. Identification information (e.g. the layer number) or the like of the layer where the focus servo operation is performed is stored in the management area. Reproduction information (management information) of the management area is supplied from the decoder 213 to the controller 214.

The controller 214 refers to the management information supplied from the decoder 213, and judges whether the layer into where the focus point has been drawn coincides with the targeted layer (Step S107). If it is judged that the layer into where the focus point has been drawn does not coincide with the targeted layer (NO in Step 107), the routine returns to Step S102, and a focus drawing operation with respect to the targeted layer is performed again. If, on the other hand, it is judged that the layer into where the focus point has been drawn coincides with the targeted layer (YES in Step S107), a reproducing operation from the layer where the focus servo operation has been performed is performed (Step S108).

In the case where a focus point is drawn into a layer contiguous to the targeted layer in the laminated direction, the reproduction RF signal is cut off by the filtering circuit selected and set by the switching circuits 209 and 212. Accordingly, in Step S106, a signal based on a decoding disable flag is supplied from the decoder 213 to the controller 214. In this case, the controller 214 judges that the layer into where the focus point has been drawn does not coincide with the targeted layer (NO in Step S107). Then, the routine returns to Step S102, and a focus drawing operation is performed with respect to the targeted layer again.

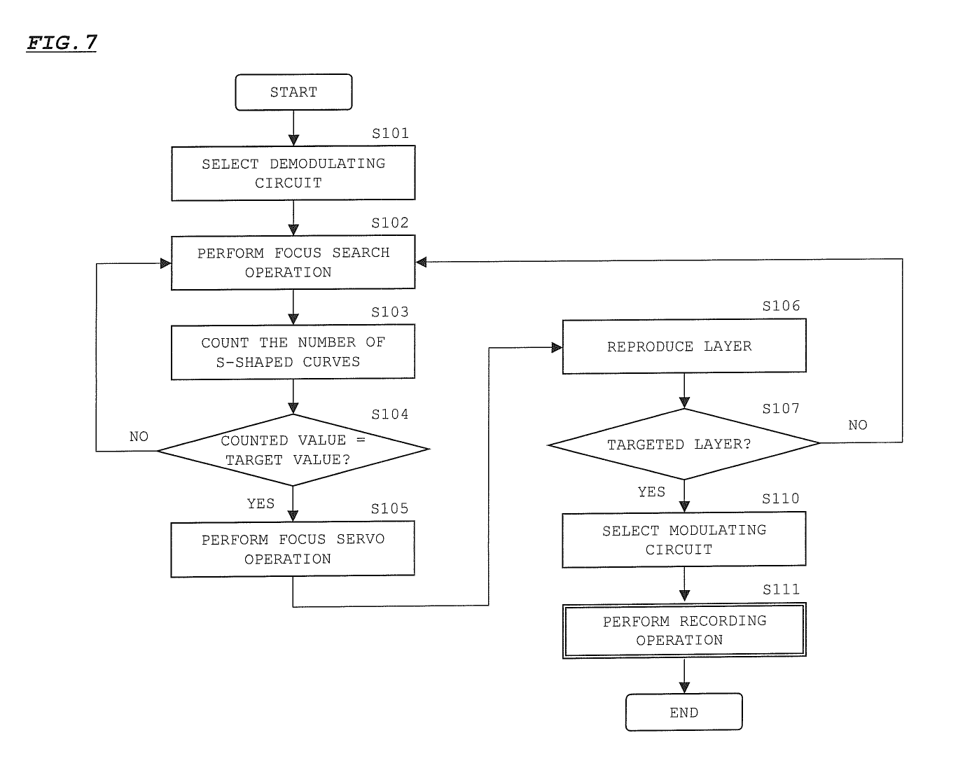

FIG. 7 is a flowchart showing an operation flow in performing a recording operation.

When a recording operation is started, operations similar to the operations from Step S101 through S107 in FIG. 6 are performed to access a targeted layer to be recorded. If the targeted layer is accessed (YES in Step S107), the switching circuits 202 and 204 are set to select a recording route corresponding to the targeted layer between the first and the second recording routes (Step S110). Thereafter, the optical pickup device accesses a target position on the layer where a focus servo operation is performed to perform a recording operation (Step S111).

As described above, in the embodiment, even if unwanted reflection light (stray light) from upper and lower layers contiguous to a targeted layer is simultaneously incident onto the photodetector 112 for receiving reflection light (signal light) from the targeted layer, a reproduction signal component resulting from stray light is cut off by the first filtering circuit 210a or the second filtering circuit 210b. This enables to suppress degradation of the quality of a demodulated signal resulting from stray light, and allows for a smooth and optimum reproducing operation.

In the embodiment, in reproducing from the third layer (layer 3) from the incident side of laser light, light (stray light) reflected on the first layer (layer 1) and the fifth layer (layer 5) are simultaneously incident onto the photodetector 112. The frequency bands of reproduction signal components of the stray light are substantially equal to the frequency band of the reproduction signal component resulting from reflection light (signal light) from the third layer. Accordingly, it is impossible to cut off the light in the frequency bands of the reproduction signal components resulting from the stray light by the first filtering circuit 210a.

However, since the layer 1 and the layer 5 are located far away from the layer 3 as the targeted layer in the layer-to-layer direction, light (stray light) reflected on the layer 1 and the layer 5 is largely spread on the photodetector 112, and does not substantially affect the signal from the photodetector 112. Accordingly, even if light (stray light) reflected on the layer 1 and the layer 5 is simultaneously incident onto the photodetector 112, a proper reproducing operation can be performed with no or less degradation of the quality of a reproduction RF signal.

The embodiment of the invention has been described as above, but the invention is not limited to the foregoing embodiment. The embodiment of the invention may be changed or modified in various ways according to needs, other than the above.

For instance, a recordable optical disc is illustrated as an example of the optical recording medium in the embodiment. Alternatively, the invention may be applied to an optical disc exclusively used for reproduction. In the modification, for instance, pit rows are formed on a recording area of each layer (semi-transparent layer) in a spiral manner. Pit rows are formed on an odd-numbered layer in such a manner that the time width of a reproduction signal is 3 T, 5 T, 6 T, 7 T, 8 T, 9 T, and 10 T; and pit rows are formed on an even-numbered layer in such a manner that the time width of a reproduction signal is 2 T and 4 T.

In the embodiment, as shown in FIG. 3, a signal from the encoder 201 is supplied to one of the first modulating circuit 203a and the second modulating circuit 203b by the switching circuit 202. Alternatively, a signal from the encoder 201 may be supplied to both of the first modulating circuit 203a and the second modulating circuit 203b, and a signal from one of the first modulating circuit 203a and the second modulating circuit 203b may be selectively supplied to the laser driving circuit 205 by the switching circuit 204.

In the embodiment, as shown in FIG. 3, a signal from the signal computing circuit 207 is supplied to one of the first filtering circuit 210a and the second filtering circuit 210b by the switching circuit 209. Alternatively, a signal from the signal computing circuit 207 may be supplied to both of the first filtering circuit 210a and the second filtering circuit 210b, and a signal from one of the first demodulating circuit 211a and the second demodulating circuit 211b may be selectively supplied to the decoder 213 by the switching circuit 212.

The conversion table is not limited to the conversion tables shown in FIGS. 4A and 4B, but a conversion method other than the above may be employed.

The embodiment of the present invention may be changed or modified in various ways according to needs, as far as such changes and modifications do not depart from the scope of the present invention hereinafter defined.

What is claimed is:

1. An optical recording medium comprising:
a first recording layer; and
a second recording layer contiguous to the first recording layer in a laminated direction, wherein
a recording is performed with respect to the first recording layer and the second recording layer in such a manner that a frequency band of a signal based on light modulated by the first recording layer in reproducing from the first recording layer is different from a frequency band of a signal based on light modulated by the second recording layer in reproducing from the first recording layer.

2. An optical recording device for recording on an optical recording medium having multiple recording layers in a laminated direction, the optical recording device comprising:
a first modulating circuit for modulating a recording signal in accordance with a first modulating method corresponding to a first recording layer;
a second modulating circuit for modulating the recording signal in accordance with a second modulating method corresponding to a second recording layer contiguous to the first recording layer in the laminated direction; and
a selecting circuit for selecting one of the first modulating circuit and the second modulating circuit, as a modulating circuit for modulating the recording signal, depending on the recording layer to be recorded, wherein
the first modulating method and the second modulating method are modulating methods different from each other in a frequency band of the modulated signal.

3. An optical reproducing device for reproducing from an optical recording medium having multiple recording layers in a laminated direction, the optical reproducing device comprising:
an extracting circuit for extracting a first frequency component corresponding to a first recording layer, and a second frequency component corresponding to a second recording layer contiguous to the first recording layer in the laminated direction respectively from a reproducing signal based on light modulated by the optical recording medium;
a first demodulating circuit for demodulating a reproducing signal of the first frequency component;
a second demodulating circuit for demodulating a reproducing signal of the second frequency component; and
a selecting circuit for selecting one of a first demodulated signal demodulated by the first demodulating circuit, and a second demodulated signal demodulated by the second demodulating circuit, as a demodulated signal to be used in the reproduction, depending on the recording layer to be reproduced.
